(19) United States
(12) Patent Application Publication
(10) Pub. No.: US 2014/0027015 A1
(43) Pub. Date: Jan. 30, 2014

(54) FILLING ELEMENT

(71) Applicants: Andreas Fahldieck, Idar-Oberstein (DE); Jonathan Lorenz, Bad Kreuznach (DE); Ludwig Clüsserath, Bad Kreuznach (DE)

(72) Inventors: Andreas Fahldieck, Idar-Oberstein (DE); Jonathan Lorenz, Bad Kreuznach (DE); Ludwig Clüsserath, Bad Kreuznach (DE)

(73) Assignee: KHS GMBH, Dortmund (DE)

(21) Appl. No.: 14/111,020

(22) PCT Filed: Apr. 5, 2012
(86) PCT No.: PCT/EP2012/001507

§ 371 Date: Oct. 10, 2013

(30) Foreign Application Priority Data
Apr. 15, 2011 (DE) 10 2011 017 263.7

(51) Int. Cl. B67C 3/28; B67C 3/26

(52) U.S. Cl. CPC B67C 3/28; B67C 3/26
USPC 141/329; 141/311 R

(57) ABSTRACT

A filling element for free jet filling of containers with liquid contents that contain solid constituents includes a housing, a contents chamber formed in the housing, and a liquid valve in the contents housing. The liquid valve comprises a valve body, and a valve opening. The valve body undergoes movement between a first position and a second position. In the first position, the valve body closes the valve opening, thereby locking the liquid valve. In the second position the valve body releases the valve opening and opens the liquid valve. The valve body is moved such that closing the valve occurs without a pump effect on the liquid contents.

### RELATED APPLICATION

This application is the national stage entry under 35 USC 371 of PCT/EP2012/001507, filed on Apr. 5, 2012 which, under 35 USC 119, claims the benefit of the priority date of German application DE 10 2011 017 263.7, filed on Apr. 15, 2011, the contents of which are herein incorporated by reference.

### FIELD OF INVENTION

The invention relates to a filling element.

### BACKGROUND

In particular with drinks, for hygiene reasons alone, a drip-free filling of the relevant content is wanted to reliably prevent dirt and thus associated risks from microbial contamination. To achieve drip-free filling, the provision of so-called gas barriers is known (DE 10 2004 013 211, DE 10 2004 022 096) for filling valves on the discharge openings by means of which the contents are introduced into the particular container, the gas barriers holding back the contents drip-free after the closure of the liquid valve of the filling element using the surface tension in the content channels of the gas barrier, the channels being connected to the liquid valve.

When filling containers with contents that contain solid constituents, for example pieces of fruit and/or fruit fibers (also called pulp) in a more liquid phase, e.g. fruit juice, there is the problem that the solid constituents accumulate and/or form lumps inside the gas barrier used and this results in blockages in and impairments to the functioning of the filling element or the filling speed achieved with it (quantity of contents introduced into the container per unit of time). To prevent adverse effects of this kind, it has already been proposed to design the valve body of the filling element in a punch-like way so that, when it is closed, it enters the apertures or holes or contents channels of the gas barrier that convey the contents and thereby cuts through or shears off any adhering solid constituents so that they cannot further accumulate, but are carried out with the contents during filling (DE 10 2004 003 489, DE 299 09 542, U.S. Pat. No. 5,822,958). The disadvantage here however is that, by the entry of the valve body, designed as a single or multiple punch, into the content channels of the gas barrier during the closing movement, a pumping effect is exerted on the contents, i.e. the contents are pushed through the content channels and/or accelerated in them, wherein there is very often a failure of the gas barrier and thus an unwanted after-dripping of the closed filling element.

### SUMMARY

It is the task of the invention to show a filling element that, with high operating reliability, even where handling contents with solid constituents, prevents unwanted after-dripping when the liquid valve is closed.

In the meaning of the invention, “containers” are in particular cans, bottles, tubes, pouches, in each case made of metal, glass and/or plastic, but also other packaging means which are suitable for filling with liquid or viscous products for pressure filling or for pressure-free filling.

In the meaning of the invention, the expression “in the main” or “approximately” means deviations from exact values in each case by +/−10%, and preferably by +/−5% and/or deviations in the form of changes not significant for functioning.

In the meaning of the invention, “free jet filling” means a process in which the liquid contents flow into the content to be filled in a free filling jet, wherein the container mouth or opening of the container does not lie against the filling element, but is at a distance from the filling element or from a contents outlet there. A substantial feature of this process is also that the air forced out of the container during the filling process by the liquid contents, does not get into the filling element or into an area or channel formed there that conveys gas, but flows freely out into the environment.

Further developments, benefits and application possibilities of the invention arise also from the following description of examples of embodiments and from the figures. In this regard, all characteristics described and/or illustrated individually or in any combination are categorically the subject of the invention, regardless of their inclusion in the claims or reference to them. The content of the claims is also an integral part of the description.

### BRIEF DESCRIPTION OF THE FIGURES

The invention is explained in more detail below by means of the figures using examples of embodiments. The following are shown:

FIGS. 1-4, in each case, in perspective sections and in different views, a filling element of a filling system or a filling machine for filling containers, in the closed state (FIGS. 1 and 2) and in the open state (FIGS. 3 and 4);

FIG. 5, a magnified partial representation of the filling element of FIGS. 1-4 in the area of the closed liquid valve;

FIG. 6, the bottom part of the housing of the filling element in FIGS. 1-5, which forms the valve seats and the outlet openings;

FIGS. 7-12, representations according to FIGS. 1-6 of a further embodiment of the filling element according to the invention;

FIG. 13, in a sketch representation and in section, the closing or valve body of a further embodiment of the filling element according to the invention, together with the housing section of the filling element, forming the valve areas and the liquid channels with outlet openings;

### DETAILED DESCRIPTION

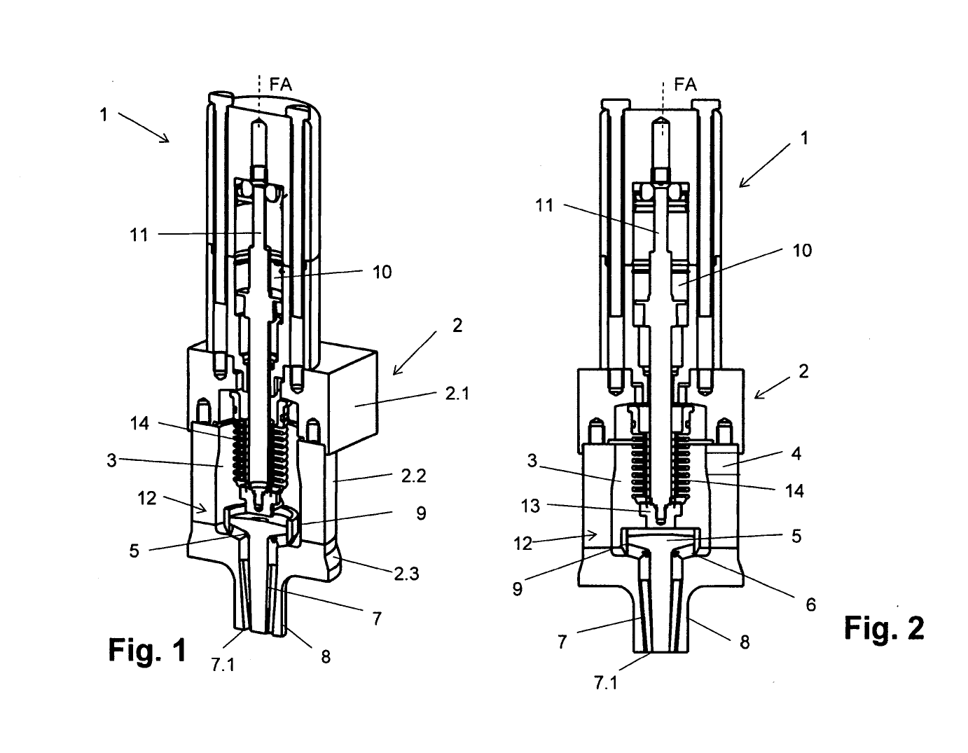

The filling element 1 in FIGS. 1-6 is a component of a filling system for filling bottles or other containers with liquid contents also containing solid constituents, for example for filling bottles or other containers with fruit juices containing pieces of fruit and/or fruit fibers (pulp) etc. The filling element 1, which is suitable in particular also for free jet filling, is to this end disposed with a multiplicity of similar filling elements 1 on the circumference of a rotor, not illustrated, that can be driven circumferentially around a vertical machine axis, as is known to the person skilled in the art.

The filling element 1 includes a multi-part filling element housing 2, in which, inter alia, a valve or contents chamber 3 is formed, that is fitted in its top area with a connection 4 to convey the liquid contents and is connected to this connection with a vessel supplying the contents, which is not illustrated. In detail, the housing 2 consists of a top, lid-type housing section 2.1, an annular housing section 2.2, and a bottom housing section 2.3 that connect to each other in the direction of a filling element axis FA and, inter alia, outwardly border the contents chamber 3. The bottom housing section 2.3 is fitted on the floor of the contents chamber 3, opposite the housing section 2.1, with a projection 5 that has a circular-cylindrical lateral or circumferential surface concentrically enclosing the vertical filling element axis FA. On the circumferential surface of the projection 5, a number of valve openings 6 are distributed around the filling element axis FA. The axes A6 of the valve opening can be disposed horizontally; however they can also include, in each case, an angle deviating from a 90° angle with the filling element axis FA. Here, the angle of the filling element axis A6 to the filling element axis FA can be both smaller and also larger than 90°.

Each valve opening 6 opens into an independent contents channel 7 that extends downwards in the direction of the filling element axis FA in an extension 8 of the housing section 2.3 and opens into the underside of the housing 2 or the spigot-type extension 8 at, in each case, a discharge opening 7.1. In the embodiment illustrated, the liquid channels 7 are made in such a way that they have a cross-section narrowing slightly in the direction of the particular discharge opening. It is however clear that, in this regard, constant cross-sections or indeed widening cross-sections can also be made.

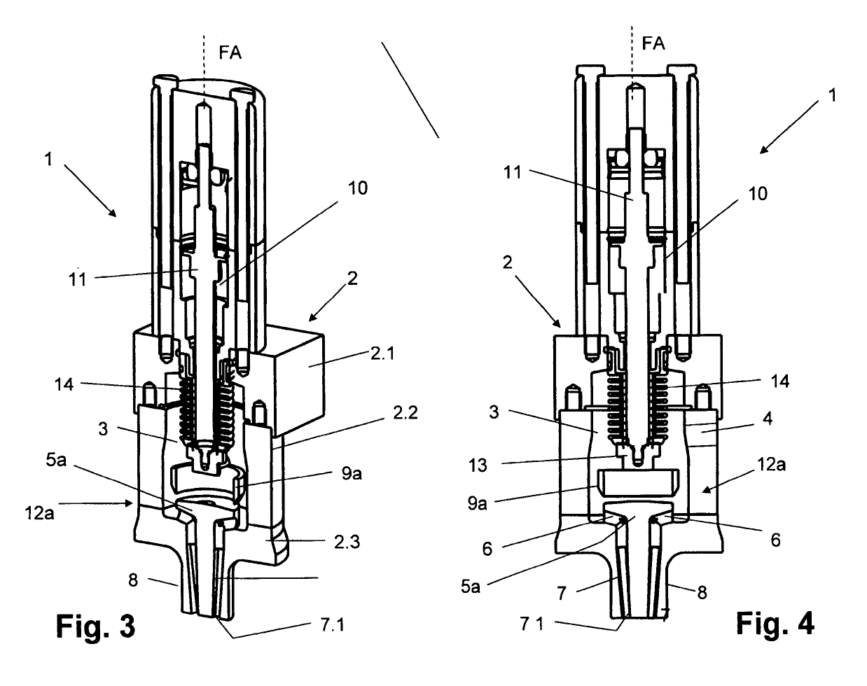

In the contents chamber 3, a closing or valve body 9 is disposed that, in the illustrated embodiment, is formed concentrically around the filling element axis in an annular shape and is fixed on the bottom end of a valve tappet 11 disposed on the same axis as the filling element FA and that can be moved axially by an actuation device. The valve body 9 forms, together with the valve openings 6 or with the circumferential surface of the projection 5 enclosing these valve openings, a liquid valve 12 of the filling element 1 that, for the controlled discharge of the contents into the relevant container (via discharge openings 7.1), is opened by the axial lifting of the valve body 9 from the position shown in FIGS. 1 and 2 into the position shown in FIGS. 3 and 4 with the release of the valve openings 6 and is closed again by an axial movement downwards with the valve tappet. The internal diameter of the annular valve body 9 is equal to the external diameter that has the projection 5 on its circumferential surface, so that the valve body 9, with the liquid valve 12 closed, covers the valve openings 6 and closes them completely and tightly. With liquid valve 12 open, the valve body is raised, as shown in FIGS. 3 and 4 so that it is at an axial distance above the projection 5.

As the figures also show, the bottom edge 9.1 of the valve body 9 turned towards housing section 2.3 is made in the shape of a knife edge so that solids that are, by chance, in the area of the particular valve opening 6 when the liquid valve 12 is closed are cut through or sheared off with this edge 9.1. The valve openings 6 also form particularly marked cutting edges for shearing off solids, in particular with the bottom area of their opening edge. By means of at least one additional seal not illustrated, when the liquid valve 12 is closed, not only a hydraulically tight separation between the contents chamber 3 and each valve opening 6, but also a tight hydraulic separation between the valve openings 6 or between the liquid channels 7 is achieved. In this way, it is possible to make the liquid channels 7 in such a way that they act overall as a gas barrier that, when liquid valve 12 is closed, prevents the after-dripping of contents from the valve openings 6 and the liquid channels 7.

Due to its design as a ring, the valve body 9 can be put on the projection 5 to close the liquid valve 12 without the contents, or indeed solids in the contents, being pressed between the surfaces of the valve body 9 and the projection 5, whereby a sticking and/or clumping of solids in the area of the liquid valve 12 is avoided so as to fill the contents with as little contamination as possible. To connect the valve tappet 11 to the annular valve body 9, a strip 13 is provided on the top side of this valve body. Furthermore, the penetration of the valve tappet 11 through the top housing section 2.1 is sealed by a bellows seal 14.

The particular advantage of filling element 1 consists, inter alia, of the valve body 9 being moved, when being closed, in the direction of the filling element axis FA, i.e. in an axial direction which is oriented diagonally to axis A6 of the valve openings 6 and thus also diagonally to the direction of flow of the contents when entering the valve openings, i.e. when flowing through the liquid valve 12. In this way, when the liquid valve 12 is closing, no pump effect is exerted on the contents by the valve body 9 that is moving into the closed position.

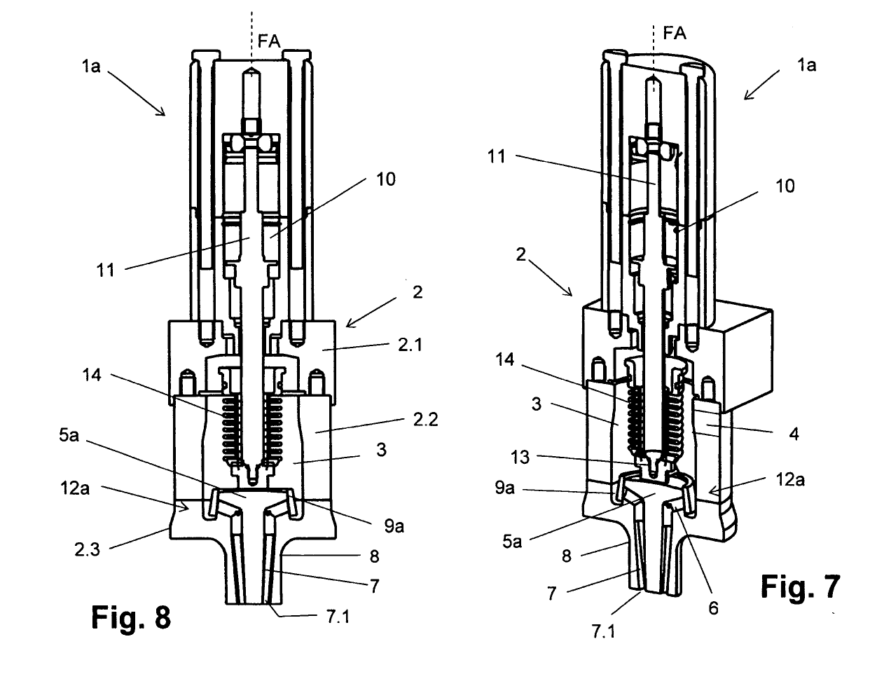

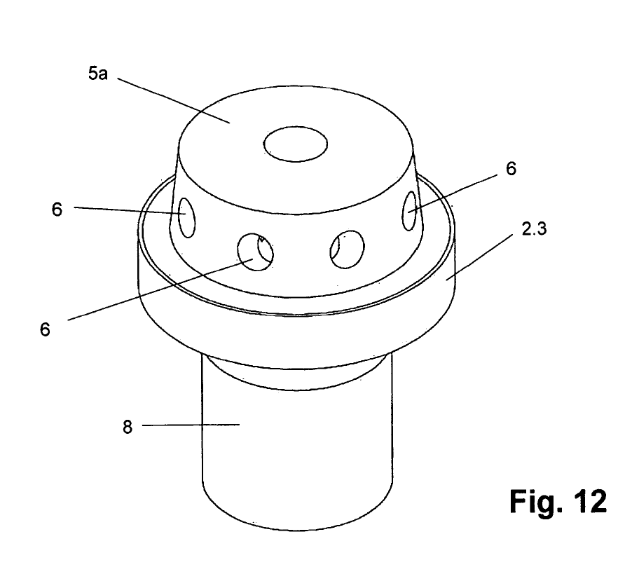

The filling element 1a shown in FIGS. 7-12 differs from the filling element 1 in the main only in that the projection 5a corresponding to the projection 5 is made so that it narrows frustoconically on the floor of the contents chamber 3 or on the bottom housing section 2.3, i.e. is designed with a conical lateral surface concentrically enclosing the filling element axis FA, and indeed in such a way that the external diameter of the projection 5a decreases to the top of the projection 5a housed in the contents chamber 3 turned towards the housing section 2.1. The projection 5a is in turn fitted with the valve openings 6, the axes A6 of which are oriented radially or in the main radially to the filling element axis FA and that, in each case, are connected to a liquid channel 7, forming a discharge opening 7.1, in the extension 8.

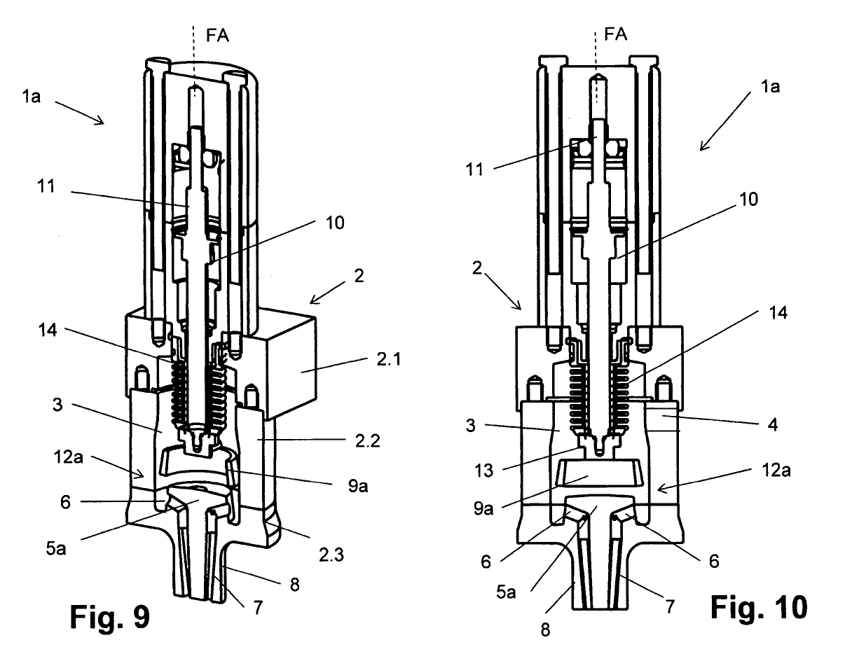

Corresponding to the shape of the projection 5a, the valve body 9a interacting with the valve openings 6 and together with them forming the liquid valve 12a is designed as a conical ring that, in the closed state of the liquid valve 12a (FIGS. 7, 8 and 11), lies flat and tight against the conical lateral surface or circumferential surface of projection 5a. In this way, not only are the valve openings 6 sealed tight against contents chamber 3, but the hydraulic separation between the valve openings 6 and thus between the individual contents channels 7, which is important for the gas barrier effect, is achieved. In the open state of the liquid valve 12a, the valve body 9a with the valve tappet 11 is raised axially in relation to the filling element axis FA so that it is at a clear axial distance above the projection 5a, as shown in FIGS. 9 and 10.

A further important advantage of the valve body 9a of an annular design consists of it already being washed sufficiently by the contents where the filling valve is completely opened to discharge the contents so that a separate cleaning station or a separate cleaning hub for cleaning the valve body can be completely omitted.

It is self-evident that the ease with which the valve body 9a can be cleaned is achieved both in the frustoconical and also in the cylindrical embodiment.

With filling element 1a, when the liquid valve 12a is closed, likewise a pump effect exerted on the contents by the valve body 9a, which could lead to a spraying or foaming of the contents, is avoided as the closing movement of the valve body 9a is again oriented diagonally to axis A6 of the valve openings 6 and thus to the direction of flow of the contents in the area of these valve openings or of the liquid valve 12a. Solid constituents of the contents that are, by chance, in the area of the liquid valve 12a or in the area of the valve openings 6 when the liquid valve 12a is closed are again cut off between the bottom edge 9a and the filling edge of the particular valve opening 6.

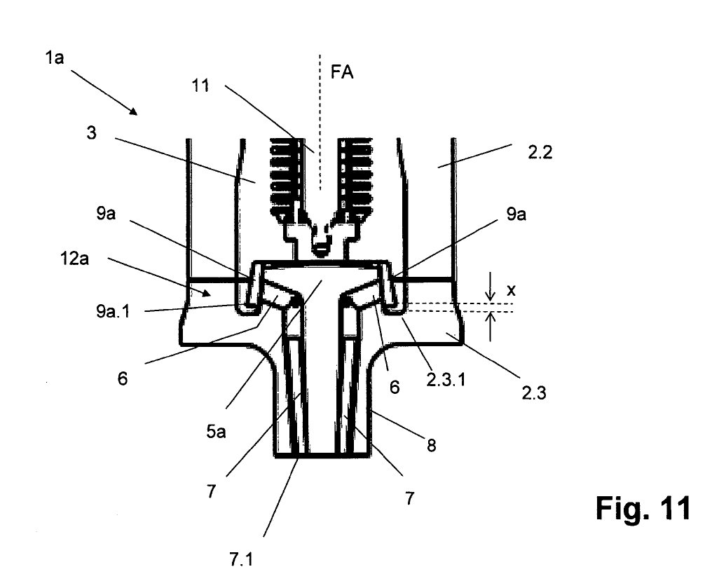

As can be seen in particular from FIG. 11, when liquid valve 12a is closed, the bottom edge 9a of the valve body 9a is at an axial distance x from the floor area of the contents chamber 3, enclosing projection 5a. To make this possible, the inner surface of housing section 2.3 for example is designed with a recess 2.3.1 enclosing the projection 5a in an annular manner. In this way, in particular a pressing and sticking and/or clumping of sheared-off or other solid constituents of the contents on the floor of the contents chamber 3 is avoided, which would be undesirable at the very least on hygienic grounds.

Due to the conical shape of projection 5a and the valve body 9a, it is possible to make these components with bigger tolerances, whereby a considerable reduction in manufacturing costs can be achieved. Here, the tight closure of the valve openings 6 is particularly reliably achieved due to the conical shape.

The conical shape of the projection 5a and the valve body 9a is also of huge benefit where, for example when filling hot contents, the heating and thus also the heat expansion of the components of the filling valve need to be taken into account. In comparison with the cylindrical shape, due to the conical shape, no seizing can occur in the event of temperature fluctuations or indeed even in the event of temperature differences between the valve body 9a and the projection 5a. Here, it is particularly advantageous if the angle of the conical shape is selected such that a seizing due to that is also reliably avoided.

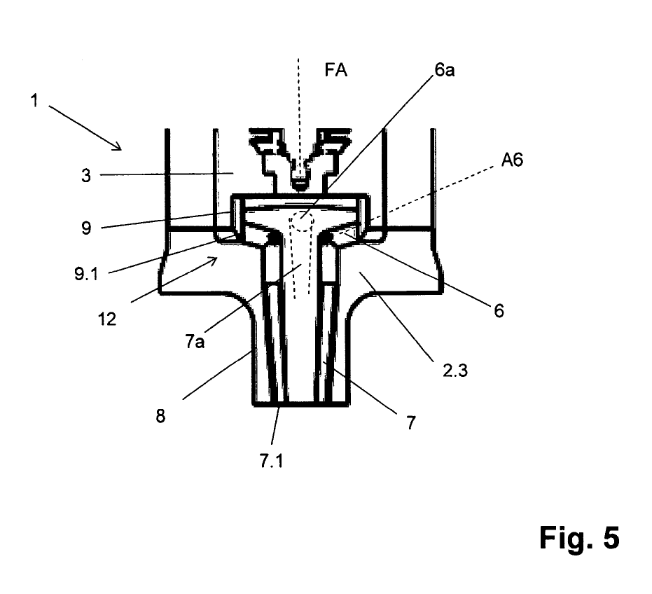

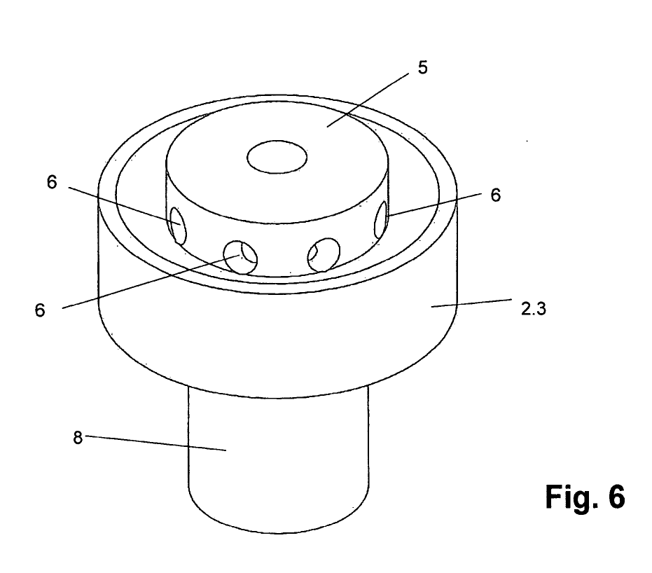

With the filling elements 1 and 1a, the valve openings 6 are in each case provided such that they open at the same height on the circumferential surface of the projection 5 or 5a, i.e. with their axes on a planned circular line concentrically enclosing the filling element axis FA. In order to increase the number of valve openings 6 and thus the number of contents channels 7 at a given diameter of the projection 5 and 5a, it can be expedient to arrange and/or design the valve openings 6 in such a way that they open at a different axial distance from the free top of the particular projection 5 or 5a on its lateral surface, as indicated in FIG. 5 with the valve opening identified there by 6a, which is then allocated a contents channel 7a which is made for example with the same axis as filling element axis FA. It is of course possible to provide the additional valve opening 6a multiple times, and in fact to do so in such a way that they open into a joint contents channel 7a for a number of valve openings 6a.

In a particularly advantageous embodiment, the valve body 9 or 9a is formed elastically at least at areas interacting with the projection 5 or 5a, for example by being slotted in areas which do not serve to close the valve openings 6 and 6a, i.e. with slots running along a surface line, starting at the bottom edge 9.1 or 9a.1 but ending before the top edge, or the valve body 9 or 9a is made from an elastic material, for example from an elastomer, at least partially in its areas that interact with the projection 5 or 5a. This elastic design contributes not only to create a hydraulically tight closing of the liquid valve 12 or 12a, but also avoids problems due to thermal expansion, this being due to the fact that the valve body 9, 9a can distort elastically accordingly where in particular the diameter of the projection 5 or 5a increases due to heating (e.g. in the event of the hot filling of contents into containers).

Due to the annular design of the valve bodies 9 and 9a, they are rinsed completely free of the contents after the opening of the liquid valve 12 or 12a, i.e. even on the internal surface of the ring, so that any adhering residual constituents are loosened from the valve body 9 or 9a and carried away with the contents.

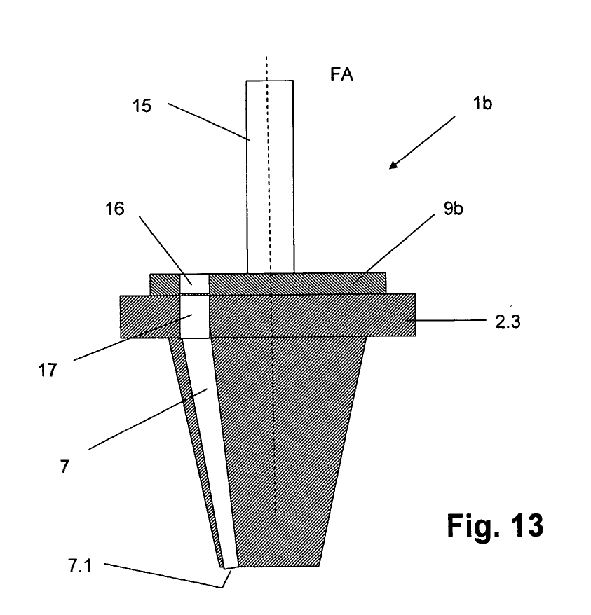

FIG. 13 shows in a very schematic representation of the liquid valve 12b a further embodiment of the filling element 1b according to the invention. In this embodiment, the valve body 9b is designed in the shape of a plate or disc and is turned or swiveled by means of the shaft 15 disposed for example on the same axis as the filling element axis FA, to open and close the liquid valve 12b in each case by a set angle around the axis of this shaft. A number of openings are provided in the valve body 9b, of which only one is shown for ease of representation and to which the valve openings 17 in the housing section 2.3, reproduced only very schematically in FIG. 13, are allocated. In the embodiment illustrated, the openings 16 and the valve openings 17, which in turn each open into a contents channel 7 forming a discharge opening 7.1, are oriented with their axes parallel to the axis of the shaft 15 and provided at the same radial distance from the axis of the shaft 15 and with the same distribution around the axis of the shaft 15. The valve openings 17 each open at the level floor area formed by the housing section 2.3 of the contents chamber 3 which is not illustrated, this being at the point where the underside of the valve body 9, which is turned away from the shaft 15 lies against the flat floor area. When closing the liquid valve 12b, the valve body 9b is in turn moved diagonally or perpendicularly to the direction of the axis of the valve openings 17 and thus perpendicularly to the direction of flow of the contents in the area of the liquid valve 12b. A pump effect on the contents is not exerted when the liquid valve 12b is closed by the valve body 9b. Solid constituents that, when the liquid valve 12b is closed, are, by chance, in the area of this valve or in the area of the openings 16 and the valve openings 17, are, when the liquid valve 12b is closed, sheared off at the edge areas acting as cutting edges of the relevant valve opening 17 and the associated opening 16.

The invention was described above using examples of embodiments. It is clear that numerous modifications and variations are possible without thereby departing from the inventive idea underlying the invention.

Thus, for example, for a further example of an embodiment of the present invention, it is provided that the smallest longitudinal distance between the next contiguous points of the drilled holes of two adjacent valve openings 6, 6a, 17 is bigger than the length of the biggest fiber to be regularly expected. By this approach, an accumulation of fibers on the projection 5, 5a or at the valve openings 6, 6a, 17 is reliably avoided as in this way the ends of a fiber projecting into different valve openings 6, 6a, 17, and thus unable to be rinsed off without special cleaning measures, is prevented.

For a further example of an embodiment of the present invention, it is planned that the valve body 9, 9a is formed elastically at least in the areas interacting with the projection 5, 5a. This can occur for example due to it being slotted in the areas that do not serve to seal the valve openings 6, 6a, 17, i.e. provided with slots running along a surface line, starting from the bottom edge 9.1, 9.a1, but ending before the top edge, whereby an elastic distortion is made possible. Alternatively, the valve body 9, 9a can be made at least partially from an elastic material, for example from an elastomer, in the areas interacting with the projection 5, 5a.

### REFERENCE DRAWING LIST

1, 1a Filling element
2 Housing
2.1-2.3 Section of housing
2.3.1 Recess
3 Contents chamber
4 Connection
5, 5a Projection
6, 6a Valve opening
7, 7a Contents channel
7.1 Discharge opening
8 Spigot-type extension
9, 9a, 9b Valve body
9.1, 9a.1 Bottom edge
10 Actuation element
11 Valve tappet
12, 12a, 12b Liquid valve
13 Strip
14 Bellows seal
15 Shaft
16 Opening in valve body 9b
17 Valve opening
FA Filling element axis

1-13. (canceled)

14. An apparatus for filling containers, said apparatus comprising a filling element for free jet filling of containers with liquid contents that contain solid constituents, said filling element comprising a filling element housing, a contents chamber formed in said housing, and a liquid valve in said contents housing, wherein said liquid valve comprises a valve body, and a valve opening, wherein said valve body undergoes movement between a first position and a second position, wherein, in said first position, said valve body closes said valve opening, thereby locking said liquid valve, wherein, in said second position said valve body releases said valve opening and opens said liquid valve, and wherein said valve body is moved such that closing said valve occurs without a pump effect on said liquid contents.

15. The apparatus of claim 14, further comprising a valve seat formed by said valve opening, wherein said valve body lies against said valve to form a seal with said valve when said valve is closed, wherein said valve has an axis that defines a main direction of flow of said liquid valve when said liquid valve is open, wherein said valve body undergoes a closing movement to form said seal, and wherein a larger component of said closing movement is oriented diagonally to said axis.

16. The apparatus of claim 15, wherein said larger component of said closing movement defines an angle relative to said axis, wherein said angle is between 1° and 179°.

17. The apparatus of claim 15, wherein said larger component of said closing movement defines an angle relative to said axis, wherein said angle is between 60° and 120°.

18. The apparatus of claim 14, wherein said valve comprises a multiplicity of valve openings interacting with said valve body.

19. The apparatus of claim 18, wherein said valve openings are distributed around an axis of movement of said valve body.

20. The apparatus of claim 18, wherein a distance between adjacent ones of said multiplicity of openings is greater than a length of a longest fruit fiber expected.

21. The apparatus of claim 14, wherein said valve opening is provided at a surface of said contents chamber, and wherein said valve body is configured to move along said surface when said liquid valve is closed.

22. The apparatus of claim 14, further comprising an annular surface that encloses an axis of movement along which said valve body moves when said valve is closed, wherein at least one of said valve opening and a valve surface formed by said valve opening is provided on said annular surface.

23. The apparatus of claim 22, wherein said annular surface is a surface of a projection, wherein said projection is selected from the group consisting of a cylindrical projection, a conical projection, and a frustoconical projection, and wherein said surface is selected from the group consisting of a lateral surface and a circumferential surface.

24. The apparatus of claim 23, wherein said valve body is formed elastically at least in areas interacting with said projection.

25. The apparatus of claim 14, wherein said valve body comprises a cylindrical ring.

26. The apparatus of claim 14, wherein said valve body comprises a conical ring.

27. The apparatus of claim 14, wherein said valve body comprises a frustoconical ring.

28. The apparatus of claim 14, wherein said valve body is at least one of rotatable and pivotable about an axis of actuation thereof to open and close said valve, wherein said valve body, when moving into a closing position, closes said valve by increasing covering and closing said valve opening against a surface having said valve opening and forming a valve seat.

29. The apparatus of claim 28, wherein said valve body is formed in a plate shape with at least one outlet opening that is superposed on said valve opening when said valve is open.

30. The apparatus of claim 14, wherein said valve opening comprises cutting edges.

31. The apparatus of claim 14, wherein said valve body comprises cutting edges.
